(19) United States
(12) Patent Application Publication
(10) Pub. No.: US 2007/0187658 A1
(43) Pub. Date: Aug. 16, 2007

(54) Staple remover

(76) Inventor: Vanamali Thotopalli, Chicago, IL (US)

Correspondence Address: Ms. Soula Skokos, Suite 220, 1100 Jorie Boulevard, Oak Brook, IL, 60523, US

(21) Appl. No.: 11/519,665

(22) Filed: Sep. 12, 2006

Related U.S. Application Data
(60) Provisional application No. 60/772,668, filed on Feb. 13, 2006.

(51) Int. Cl. B25C 11/00

(52) U.S. Cl. 254/28

(57) ABSTRACT

An improved staple remover having at least one extended finger tab to aid the user in forcing the jammed jaws of the staple remover to dislodge a lodged staple. The at least one extended finger tab may be located at a single end of each lever arm opposite of the jaws of the staple remover.

### CROSS REFERENCE TO RELATED APPLICATION

The present application is a utility application claiming the benefits of the filing date of provisional application, Application No. 60/772,668, filed on Feb. 13, 2006 by the present applicant.

### BACKGROUND OF THE INVENTION

The present invention relates generally to a staple remover. Present staple removers become jammed when a staple is lodged between the jaws of the staple remover. The present invention solves this problem by providing at least one finger tab of a predetermined length that allows the user to depress the at least one finger tab forcing the jaws of the staple remover to open.

Staple removers for removing staples from papers or documents are in common use. These devices typically include two manually operable lever arms with finger tabs that allow the user to depress such finger tabs to remove a staple from papers or documents. Oftentimes the operator may experience that the staple remover becomes jammed where the two lever arms become locked together by a staple lodged between the jaws of the staple remover. It may be difficult and time consuming to pry open the staple remover to remove the staple that is lodged between the jaws of the staple remover. Existing devices require the user to stop his or her task at hand and then apply force with both hands to pull apart the two jammed lever arms to release the lodged staple.

The staple remover of the present invention overcomes these obstacles and inconvenience of a jammed staple remover by providing the operator with finger tabs of a predetermined length to depress such finger tabs causing the jaws of the staple remover to open.

### BRIEF SUMMARY OF THE INVENTION

The present invention is directed to an improved staple remover comprising of at least one extended finger tab of a predetermined length that extends beyond the body of the staple remover opposite the jaws end of the staple remover. The at least one finger tab aids the user in pulling the jaws of the staple remover apart in the event of a staple jam. When a jam occurs, the user may press the at least one finger tab with his or her thumb and forefinger to allow staple remover to return to its normal open position. The present invention allows the user to open the staple remover with the use of only one hand thereby keeping his or her fingers of the user's other hand away from the sharp staples that have created the jam.

When the user applies a force to the at least one extended finger tab, the at least additional extended finger tab forces the jammed staple remover lever arms and jaws apart thereby releasing them from each other. Once the lever arms and jaws disengaged from each other, the lodged staple may be freely removed.

### BRIEF DESCRIPTION OF THE DRAWINGS

FIG. 1 is a perspective view of a staple remover designed in accordance with an embodiment of the present invention where the staple remover is in the “open” position;

FIG. 2 is a perspective view of a staple remover designed in accordance with an embodiment of the present invention where the staple remover is in the “closed” position;

FIG. 3 is a side view of a staple remover designed in accordance with an embodiment of the present invention where the staple remover is in the “open” position; and

FIG. 4 is a side view of a staple remover designed in accordance with another embodiment of the present invention where the staple remover is in the “open” position illustrating the serrations on the jaws of the staple remover.

### DESCRIPTION OF THE DRAWINGS

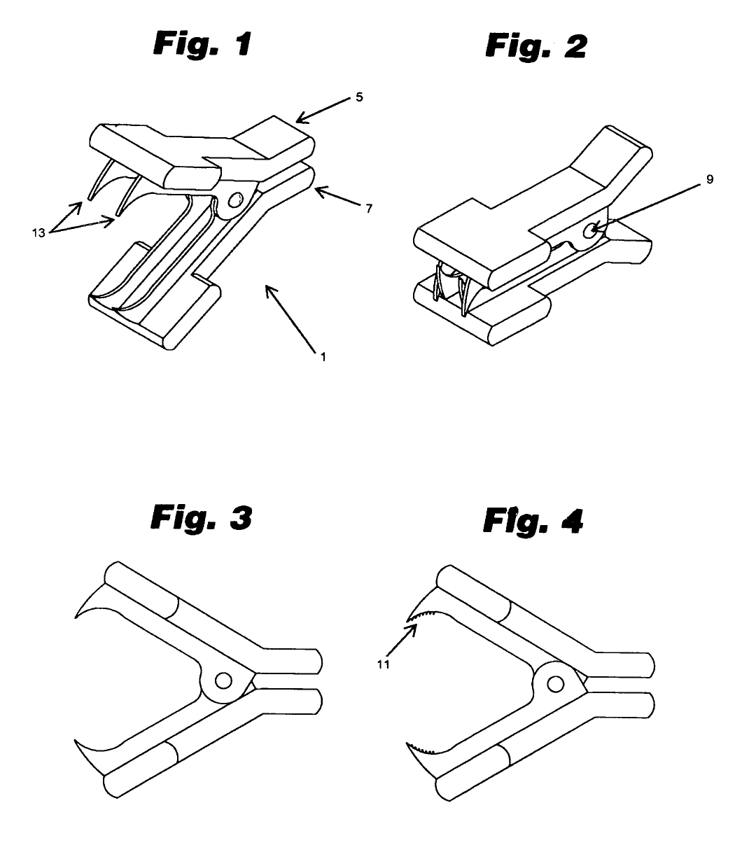

The present invention is directed to an improved staple remover (shown generally at 1 in the Figures) comprising at least one extended finger tab 5 and 7 of a predetermined length that extends beyond the body of the staple remover 1. The at least one extended finger tab 5 and 7 extends from the body of the staple remover 1 and is at the end of the staple remover 1 opposite to the jaws 13 of the staple remover 1. The at least one extended finger tab 5 and 7 may be an extension of the plastic covering of the staple remover 1, typically injection molded ABS which is used to shield the metal staple removing jaws 13 of the staple remover 1. Alternatively, the at least one extended finger tab 5 and 7 may be at least one insert that attaches to the end of the staple remover opposite to the jaws 13 of the staple remover 1, thereby allowing the user to convert present staple removers. The at least one extended finger tab 5 and 7 creates a mechanical advantage by using the at least one extended finger tabs 5 and 7 and pivot point 9 as a fulcrum point in the event of a mechanical jam. When a staple jam occurs, the at least one extended finger tabs 5 and 7 are pushed inwards with a user's thumb and forefinger to allow the staple remover jaws 13 to be forced open and the staple remover 1 to return to its normal open position as shown in FIG. 1.

Preferably, the at least one extended finger tab 5 and 7 may extend ¾ of an inch and extend from the body of the staple remover 1 at a 15 degree angle.

In one embodiment of the present invention, the jaws 13 of the staple remover 1 may have serrations 11 as shown in FIG. 4, in order to aid in the removal of staples. When the staple remover 1 is in use and the jaws 13 of the staple remover 1 are pressed together against a staple, the serrations 11 on the jaws 13 of the staple remover 1 aid in removing the staple securely by providing grooves into which the staple is secured.

In another embodiment of the invention, the at least one extended finger tab 5 and 7 may curve inward towards the body of the staple remover 1 to protect the user's fingers when the user applies force to the at least one extended finger tab 5 and 7. In another embodiment of the invention, the at least one extended finger tab 5 and 7 may curve outward away from the body of the staple remover 1 to provide the user with a better grip when the user applies force to the at least one extended finger tab 5 and 7.

In another embodiment of the invention, the at least one extended finger tab 5 and 7 may have ridges on the top surface of the at least one extended finger tab 5 and 7 to aid the user's fingers in gripping the at least one extended finger tab 5 and 7. In another embodiment of the invention, the at least one extended finger tab 5 and 7 may have a depression in the top surface of the at least one extended finger tab 5 and 7 to aid the user's fingers in gripping the at least one extended finger tab 5 and 7.

In another embodiment of the invention, the at least one extended finger tab 5 and 7 may be replaced by at least one button that may be depressed causing the jaws of the staple remover to open. The at least one button may be attached to at least two connectors that apply force to the jaws 13 of the staple remover 1 to force the jaws 13 of the staple remover 1 open.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

I claim:

1. An improved staple remover comprising:
A staple remover; and
At least one extended finger tab extending beyond the body of the staple remover.

2. An improved staple remover according to claim 1, wherein the at least one extended finger tab has ridges on the top surface of the at least one extended finger tab.

3. An improved staple remover according to claim 1, wherein the at least one extended finger tab has a depression on the top surface of the at least one extended finger tab.

4. An improved staple remover according to claim 1, wherein the at least one extended finger tab curves upward away from the body of the staple remover.

5. An improved staple remover according to claim 1, wherein the at least one extended finger tab curves inward toward the body of the staple remover.

6. An improved staple remover comprising:
A staple remover; and
At least one extended finger tab insert that may be attached to the body of the staple remover at the end of the staple remover opposite the jaws of the staple remover.

7. An improved staple remover comprising:
A staple remover; and
At least two connectors that are connected to the jaws of the staple remover; and
At least one button that is connected to the at least two connectors that may be depressed causing the jaws of the staple remover to open.
